(19) United States
(12) Patent Application Publication
(10) Pub. No.: US 2009/0162667 A1
(43) Pub. Date: Jun. 25, 2009

(54) Lighting device having backlighting, illumination and display applications

(75) Inventor: Emil Vergilov Radkov, Euclid, OH (US)

Correspondence Address: Fay Sharpe LLP, 1228 Euclid Avenue, 5th Floor, The Halle Building, Cleveland, OH, 44115, US

(73) Assignee: Lumination LLC

(21) Appl. No.: 12/004,264

(22) Filed: Dec. 20, 2007

(51) Int. Cl. B32B 17/06; B32B 9/04

(52) U.S. Cl. 428/426; 428/690

(57) ABSTRACT

The present invention provides a lighting device such as a backlighting device, and display thereof such as LCD display. The lighting device comprises one or more radiation sources such as UV-blue LED and a layer of air- and moisture-sensitive phosphor, such as complex fluoride activated with Mn⁴⁺. The phosphor layer is protected from air and moisture by placing it between two moisture/air impermeable members. The lighting device exhibits increased life, reliability and color stability over time and absence of restrictions imposed on the LED spacing, among others.

### BACKGROUND OF THE INVENTION

The present invention relates to a lighting device such as a backlighting device and a display device thereof. More particularly, the lighting device comprises a radiation source and a layer of protected phosphor.

Backlight products currently available in the market place typically utilize cold cathode fluorescent lamp (“CCFL”) technology to backlight the product. Although CCFL technology is an inexpensive way to backlight a product, the technology is limited in terms of its power consumption and energy efficiency, mercury usage, low color gamut, and limited brightness. Additionally, CCFL technology has spacing requirements that are inconsistent with current trends of making products thinner and smaller in response to the desires of today's consumers.

LED-phosphor system can also be used for backlighting. However, current backlight designs using phosphor-coated panels cannot provide sufficient protection for phosphors that are sensitive to air and moisture. Due to the problem of hydrolysis or oxidation of the phosphors, the backlighting products have a shortened lifespan, and poor performance.

For example, U.S. Pat. No. 6,844,903 to Mueller-Mach and Mueller teaches the use of the moisture-sensitive phosphors SrS:Eu²⁺ and SrGa₂S₄:Eu²⁺. However, the patent does not provide means for protection of the phosphor from the atmospheric elements. U.S. Pat. No. 7,052,152 to Harbers and Collins does not specify the nature of the phosphors and does not appear to provide protection from the atmosphere. In addition, U.S. Pat. No. 7,052,152 imposes restrictions on the spacing of the LEDs and on the back wall of the BL being reflective.

Advantageously, the invention provides a lighting device such as a backlighting device which exhibits numerous technical merits including increased life and reliability, increased light output due to using highly efficient and highly saturated air- or moisture-sensitive phosphors, increased color stability over time due to the protection of said phosphors, absence of restrictions imposed on the LED spacing, absence of restrictions imposed on the reflectivity of the internal walls and bottom of the device, and absence of restrictions imposed on the height to LED pitch ratio, among others.

### BRIEF DESCRIPTION OF THE INVENTION

One aspect of the invention provides a lighting device such as a backlighting device comprising a radiation source and a layer of moisture sensitive phosphor located between opposed at least substantially transparent members. The members are formed of a material substantially impervious to the external environment, such as atmosphere. In certain embodiments, the members can be cooperatively curved in shape, and in other embodiments, substantially flat plates may be advantageous. Optionally, the lighting device further comprises a refractive index (RI) matching layer and/or a diffuser layer.

Another aspect of the invention provides a display device such as a LCD display comprising the aforementioned lighting device such as a backlighting device, a polarizer, an array of thin film transistors (TFT), and a color filter. Optionally, the LCD display device further comprises a brightness enhancement filter or brightness enhancing film (“BEF”), a UV filter, and a mask.

### BRIEF DESCRIPTION OF THE DRAWINGS

FIG. 1 depicts the side view of an exemplary display device which comprises a lighting device according to an embodiment of the present invention;

FIG. 2 shows the spectral power distribution of a backlight using a phosphor blend (K₂[TiF₆]:Mn⁴⁺+SrGa₂S₄:Eu²⁺) with blue LED chips as the light source according to an embodiment of the present invention;

FIGS. 3 and 4 diagrammatically show perspective and side-cross-sectional views, respectively, of a side-emitting light emitting diode (LED) device with coupled wavelength conversion element;

FIG. 5 diagrammatically shows a perspective view of an array of devices of the embodiment shown in FIGS. 1 and 2;

FIG. 6 diagrammatically shows a planar light source based on the array of devices of FIG. 5;

FIG. 7 diagrammatically shows a liquid crystal display (LCD) panel coupled with a backlight comprising the planar light source of FIG. 6;

FIG. 8 diagrammatically shows a side view of the array of devices of FIG. 5 with intervening light scattering elements; and

FIG. 9 diagrammatically shows a side view of an array of devices similar to those of FIGS. 3 and 4 with modified reflectors.

### DETAILED DESCRIPTION OF THE INVENTION

The phosphor in the lighting device of the invention can be selected from any phosphors that are sensitive to oxygen, air, and/or moisture. Preferably, the phosphor will exhibit desirable properties for use in backlighting applications, such as high spectral purity and high efficiency.

Air or moisture sensitivity can be imparted to phosphors from the host lattice (e.g. if it contains at least one chalcogenide ion prone to hydrolysis and/or oxidation), the activator (e.g. Mn⁴⁺ which is prone to hydrolysis in certain host lattices such as complex fluorides), or both (e.g. (Sr,Ca)O: Eu²⁺).

Phosphors based on host lattices containing sulfide, selenide, telluride ions or mixtures thereof, preferably activated with at least one of Ce³⁺ and Eu²⁺ (e.g. alkaline earth sulfides, selenides, sulfoselenides), thiogallates and thioaluminates activated with at least one of Ce³⁺ and Eu²⁺, oxysulfides activated with at least Eu³⁺, and complex fluorides activated with Mn⁴⁺, and any combination thereof would particularly benefit from the present invention.

Examples of sulfides activated with Eu²⁺/Ce³⁺ include, but are not limited to, (Ca,Sr,Ba)S:Ce³⁺,Eu²⁺, SrY₂S₄:Ce³⁺,Eu²⁺ and CaLa₂S₄:Ce³⁺,Eu²⁺. Examples of other chalcogenides activated with Eu²⁺ include, but are not limited to, (Ca,Sr,Ba)(S,Se,Te):Eu²⁺.

Examples of thiogallates activated with Eu²⁺ include, but are not limited to, (Ca,Sr,Ba)(Al,Ga,In)₂S₄:Eu²⁺ and (Ca,Sr,Ba)₂(Al,Ga,In)₂S₅:Eu²⁺.

Examples of thioaluminates activated with Eu²⁺ include, but are not limited to, (Ca,Sr,Ba)(Al,Ga,In)₂S₄:Eu²⁺, (Ca,Sr,Ba)₂(Al,Ga,In)₂S₅:Eu²⁺, and (Ca,Sr,Ba)(Al,Ga,In)₄S₇:Eu²⁺.

For the purposes of this application, whenever several different host lattice constituent elements are listed inside the formula of a phosphor separated by one or more commas, it is meant that they can participate interchangeably in any given ratio allowed by the stoichiometry coefficient. For example, the formula (Ca,Sr)(S,Se): Eu²⁺ is equivalent to (CaₓSr₁₋ₓ)(S_{y}Se_{1-y}): Eu²⁺, where x and y can take independently any values from 0 to 1, including 0 and 1. (As customary in the art, the activator is listed separated by a colon from the host lattice and is physically incorporated into the latter, even if not added explicitly into the stoichiometric indices or coefficients.) Further, when several activator ions are listed after a colon separated by one or more commas, it is meant that the phosphor is activated with at least one of these ions. For example, the notation CaS: Eu²⁺, Ce³⁺ has the same meaning as calcium sulfide activated with Ce³⁺, or Eu²⁺, or both Ce³⁺ and Eu²⁺.

Examples of oxysulfides activated with at least Eu³⁺ include, but are not limited to, (Y,Gd,Lu,La)₂O₂S: Eu³⁺ and (Y,Gd,Lu,La)₂O₂S: Eu³⁺, Bi³⁺.

Examples of complex fluorides activated with Mn⁴⁺ include, but are not limited to, (1) A₂[MF₆]:Mn⁴⁺, where A is selected from Li, Na, Rb, Cs, NH₄, and combinations thereof; and where M is selected from Ge, Si, Sn, Ti, Zr, Hf and combinations thereof; and (2) A₃[MF₆]:Mn⁴⁺ where A is selected from Li, Na, Rb, Cs, NH₄, and combinations thereof; and where M is selected from Al, Ga, In Bi, Sc, Y, a rare earth and combinations thereof.

Specific examples of complex fluorides activated with Mn⁴⁺ include, but are not limited to, K₂[TiF₆]:Mn⁴⁺, (K,Cs)₂ [SiF₆]:Mn⁴+, and K₃[BiF₆]:Mn⁴⁺.

Different phosphors, e.g. a green emitting phosphor and a red emitting phosphor, may be combined for desirable backlighting performance. For example, the blend of SrGa₂S₄:Eu²⁺ and K₂[TiF₆]:Mn⁴⁺ can be used, as shown further below.

One or more additional phosphors can be combined with the one or more moisture- and air-sensitive phosphors as described above. For example, a blue emitting phosphor can be used in a blend with a green and a red emitting phosphor, to make use of violet to UV emitting LED chips (i.e. with peak wavelength less than 440 nm). The additional phosphors can be selected from the group including, but not limiting to: (Ba,Sr,Ca)₅(PO₄)₃(Cl,F,Br,OH):Eu²⁺,Mn²⁺; (Ba,Sr,Ca)BPO₅:Eu²⁺,Mn²⁺; (Sr,Ca)₁₀(PO₄)₆*vB₂O₃: Eu²⁺ (wherein 0<v≦1); Sr₂Si₃O₈*2SrCl₂:Eu²⁺; (Ca,Sr,Ba)₃MgSi₂O₈: Eu²⁺, Mn²⁺; BaAl₈O₁₃: Eu²⁺; 2SrO*0.84P₂O₅*0.16B₂O₃:Eu²⁺; (Ba,Sr,Ca)MgAl₁₀O₁₇:Eu²⁺,Mn²⁺; (Ba,Sr,Ca)Al₂O₄:Eu²⁺; (Y,Gd,Lu,Sc,La)BO₃:Ce³⁺,Tb³⁺; ZnS:Cu⁺,Cl⁻; ZnS:Cu⁺,Al³⁺; ZnS:Ag⁺,Cl⁻; ZnS:Ag⁺,Al³⁺; (Ba,Sr,Ca)₂Si_{1-ξ}O₄O_{4-2ξ}O_{:Eu}²⁺ (wherein 0≦ξ≦0.2); (Ba,Sr,Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)₃(Al,Ga)_{5-α}O_{12-3/2α}:Ce³⁺ (wherein 0≦α≦0.5); (Ca,Sr)₈(Mg,Zn)(SiO₄)₄Cl₂:Eu²⁺,Mn²⁺; Na₂Gd₂B₂O₇:Ce³⁺,Tb³⁺; (Sr,Ca,Ba,Mg,Zn)₂P₂O₇:EU²⁺,Mn²⁺; (Gd,Y,Lu,La)₂O₃:EU³⁺Bi³⁺; (Gd,Y,Lu,La)₂O₂(S,Se,Te):Eu³⁺, Bi³⁺; (Gd,Y,Lu,La)VO₄:Eu³⁺, Bi³⁺; (Ba,Sr,Ca)MgP₂O₇:Eu²⁺, Mn²⁺; (Y, Lu)₂WO₆:Eu³⁺,Mo⁶⁺; (Ba,Sr,Ca)_{β}Si_{γ}N_{μ}:Eu²⁺ (wherein 2β+4γ=3μ); Ca₃(SiO₄)Cl₂:Eu²⁺; (Lu,Sc,Y,Tb)₂₋ᵤ₋ᵥCeᵥCa₁₊ᵤLi_{w}Mg_{2-w}(Si,Ge)_{3-w}O_{12-u/2} (where −0.5≦u≦1, 0≦v≦0.1, and 0≦w≦0.2); (Y,Lu,Gd)_{2-φ}Ca_{φ}Si₄N_{6+φ}C_{1-φ}:Ce³⁺, (wherein 0≦φ≦0.5); (Lu,Ca,Li,Mg,Y)alpha-SiAlON doped with Eu²⁺ and/or Ce³⁺; (Ca,Sr,Ba)SiO₂N₂:Eu²⁺,Ce³⁺; 3.5MgO*0.5MgF₂*GeO₂:Mn⁴⁺; Ca_{1-c-f}Ce_{c}Eu_{f}Al_{1+c}Si_{1-c}N₃, (where 0<c≦0.2, 0≦f≦0.2); Ca₁₋ₕ₋ᵣCeₕEu_{f}Al₁₋ₕ(Mg,Zn)ₕSiN₃, (where 0<h≦0.2, 0≦r≦0.2); Ca₁₋₂ₛ₋ₜCeₛ(Li,Na)ₛEuₜAlSiN₃, (where 0≦s≦0.2, 0≦f≦0.2, s+t>0); and Ca_{1-σ-χ-φ}Ce_{σ}(Li,Na)_{χ}EuφAl_{1+σ+χ}N₃, (where 0≦σ≦0.2, 0<χ≦0.4, 0≦φ≦0.2).

Typically, the phosphor blend will be suspended and cured in a carrier medium such as epoxy, silicone or silicone epoxy, to form a layer. The carrier medium must be compatible with all phosphor components of the blend. For example, phosphors containing sulfur or selenium could be incompatible with any silicone that uses a platinum-based catalyst to cure (since the sulfide or selenide ion will inactivate the catalyst, thereby preventing curing). Acceptable carrier materials for such phosphors could include silicones that do not use transition metal-based catalysts, as well as epoxies.

In exemplary embodiments, the phosphor layer is isolated from the external environment by sealing between two moisture/air impermeable plates with a perimeter sealant. The perimeter sealant is preferably a material impermeable to moisture, air or both, according to the sensitivity of the phosphor(s) being protected.

The moisture/air impermeable plates can be for example made of optical glass (which can be any of the types typically used in flat panel and LCD displays, such as 1737F, AF45 or D263) or of certain plastics, e.g. polycarbonate coated with a graded single inorganic/organic hybrid layer that prevents moisture permeation as disclosed in Kim et al. J. Vac. Sci. Tech. A vol. 23, pp. 971-977 (2005) and references therein.

Preferably, the material used as the phosphor carrier medium will have an index of refraction close to or matching that of the material used for making the impermeable plates (1.51-1.53 for the glass examples above). Optical grade epoxies and silicones that can meet this requirement are known in the art.

The perimeter seal can be for example made of a thermally or UV curable adhesive, preferably one-part adhesive. The merits of a one-part adhesive are that no two part mixing is required; cure can be done on demand; it is environmentally friendly; the curing is faster and stronger; adhesive shrinkage is minimized; and humidity resistance is increased.

In various embodiments, the perimeter seal can be made of a UV curable plastic, such as UV curable acrylic or UV epoxie. UV curable acrylics include ELC-4M01 sold by Electro-lite Corp. UV curable epoxies include ELC-2500 or ELC-2900 series sold by Electro-lite Corp., and DP031199-1 cationic UV epoxy adhesive sold by Resin Technology Group.

In preferred embodiments, the perimeter sealant can be selected from those encapsulants used in the manufacture of LEDs such as LED grade epoxies (e.g. Hysol OS4000 and the like, available commercially from Loctite).

Optionally, the perimeter seal may also comprise a protective coating, or adhesive tape, applied on the entire outer circumference of the device. Preferably, said adhesive tape comprises at least one layer of air- and moisture-impermeable material, such as aluminum or another suitable metal.

In an embodiment, the medium carrying the phosphor can be cured between the two glass plates thermally or by light, and then the “sandwich” of the phosphor between two plates can be sealed on the perimeter, e.g. with the epoxy OS4000.

In another embodiment, one or more RI matching layers, preferably thermally cured, can be added on one or both sides of the phosphor layer. A RI matching layer is useful to eliminate an optical gap between a glass plate and the phosphor layer, for example if the phosphor layer has been already coated and cured on the opposing glass plate, and then the assembly is to be continued by adding the other plate. Preferably, the RI matching layer will have an index of refraction matching that of the medium carrying the phosphor. Examples of RI matching layer materials include, but are not limited to, the materials suitable for carrying the phosphor (epoxies, silicones and silicone epoxies), mentioned above.

The radiation source used in the present invention is typically selected from UV and visible light source. The light source can be selected from a cold cathode fluorescent lamp, a hot cathode fluorescent lamp, a light emitting diode (LED), or an electroluminescent element. Preferably, the light source comprises one or more LEDs. LEDs may be arranged in any particular pattern on panel.

The preferred peak emission of the LED chip will depend on the identity of the phosphors used and may range from, e.g., 250-550 nm. In one preferred embodiment, however, the emission of the LED will be in the near UV to blue-green region and have a peak wavelength in the range from about 370 to about 500 nm.

Preferably, the LED chips used will emit radiation with substantially the same wavelength, for example radiation having a peak wavelength range of no more than 10 nm, more preferably having a peak wavelength range of no more than 5 nm.

Any suitable manner can be adopted to illuminate the secured phosphor layer and the display with the LED light source, including direct-lighting, edge-lighting or side-lighting. For example, the invention can use direct backlighting with LEDs placed near the phosphor layer face-to-face, a direct backlighting with side emitting LEDs, or a waveguide and edge illumination. Preferably, the lights from the LED sources can travel a long mixing length to lessen the flux and color variations that are inherent to LEDs. In the direct backlighting, each LED illuminates a large area of the phosphor layer and display panel such as a LCD. In other words, each pixel of the LCD is illuminated by a number of LEDs such that variations in output of each LED are reduced in the LCD image. In exemplary embodiments, phosphors emitting different colors and different LED chips can be combined to provide desired backlighting effect.

Optionally, a light diffuser can be placed between the radiation source(s) and the phosphor layer. A diffuser can further balance the intensity distribution of light backlighting the phosphor layer as well as the display. In case of one point radiation source, a diffuser needs to cover the output aperture. Preferably, a diffuser uniformly diffuses the radiation. The substrate of a diffuser can use any suitable construction materials, which preferably are impermeable to air and/or moisture, for example glass and/or a transparent polymeric material such as polymethylmethacrylate (PMMA), polystyrene, styrene-acrylonitrile, and polycarbonate.

In one embodiment, a diffuser uses a substrate which has a transmittance of at least about 50% of the light that it receives, more preferably at least about 75%, and even more preferably at least about 90%.

In an embodiment, the diffuser is a refractory diffuser. The diffuser may also have an etched substrate or a substrate having a random ribbed pattern (a random diffuser). It can also be a uniform diffuser. For example, a uniform diffuser may be a holographic diffuser designed to spread light out over a specified range of angles in two perpendicular directions in the plane of the diffuser.

The lighting device of the invention exhibits numerous technical merits, which include, for example, increased life and reliability, increased light output due to using highly efficient and highly saturated air- or moisture-sensitive phosphors, absence of restrictions imposed on the LED spacing, absence of restrictions imposed on the reflectivity of the internal walls and bottom of the device, and absence of restrictions imposed on the height to LED pitch ratio. Any height to LED pitch ratio can be used, for example, a mosaic of closely spaced low power LEDs may be more cost-efficient over scarcely spaced high power LEDs as in U.S. Pat. No. 7,052,152.

The total of the light from the secured phosphor and the LED chip(s) provides a color point with corresponding color coordinates (x and y) and correlated color temperature (CCT). Typical displays have a CCT of 6500K, but higher or lower values are readily achievable, as known in the art.

The display device comprising the aforementioned lighting device such as a LCD display comprising a polarizer, an array of thin film transistors (TFT), and a color filter. Optionally, the LCD display device further comprises a brightness enhancement filter or brightness enhancing film (“BEF”), a UV filter, and a mask.

Exemplary display devices of the invention include, but are not limited to, large-scale flat screens, computer displays, and TV displays (including large-scale displays e.g. greater than 50 in). In an embodiment, the invention is related to backlighting a liquid crystal display (LCD) panel.

A LCD flat panel consists of many individual pixels, and each pixel may be comprised of one or more liquid crystal cells. Each liquid crystal cell operates as a shutter, allowing light to go through a pixel (or sub-pixel) when “open” and not allowing light to go through a pixel (or sub-pixel) when “closed”.

Two polarizers can be used with the liquid crystal cells in performing the shutter function. Light can be viewed as having two components, i.e. a horizontally polarized component and a vertically polarized component. For example, a first polarizer can be placed before liquid crystal cells, which only allows vertically polarized component to exit and then enters liquid crystal cells, thus blocking the horizontally polarized component. The liquid crystal can twist the vertically polarized light into a horizontally polarized light. A second polarizer can be placed after the liquid crystal cells, which only allows horizontally polarized light to pass through. When the horizontally polarized light leaves the liquid crystal cell, it can pass through the second polarizer, and the shutter can be viewed as open. However, if the liquid crystal can not twist the vertically polarized light into a horizontally polarized light, the shutter is closed.

Whether the liquid crystal can twist the light depends on whether a voltage is applied on the liquid crystal. When a voltage is applied, the crystal molecules arrange themselves along the electric field. Because of this re-alignment, when a vertically polarized component enters the liquid crystal, it is not twisted, but merely passes through unchanged. Thus, the vertically polarized component exiting from liquid crystal is blocked by the second polarizer from passing through. In other words, when the voltage is on, the shutter is closed, and when the voltage is off, the shutter is open. This type of configuration is called a positive image LCD. If both the first and second polarizers allowed vertically polarized light through, then the effect would be reversed: when the voltage is on, the shutter is open, and when the voltage is off, the shutter is closed. This type of configuration is called a negative image LCD.

An array of thin film transistors (TFT) can be used as switching elements to open or close the liquid crystal shutters. Each thin film transistor turns an individual pixel or sub-pixel on or off. The substrate for TFT can be made of glass and has the addressing elements for the liquid crystal layer. Because the TFT switching elements are active elements, this type of LCD device is called an active matrix display. By contrast, a passive matrix display has electrodes on both sides of liquid crystal layer. One side, or substrate, would contain columns of electrodes and the other side, or substrate, would have the rows of electrodes. For example, to turn on or off a particular sub-pixel in a passive matrix display, the appropriate column containing that sub-pixel's first electrode is charged and the particular row containing that sub-pixel's second electrode is grounded. The present invention is not limited to either passive or active matrix displays.

In order to create the colors of the visible spectrum, each color is broken down into percentages of single-color components. Typically, the single color components are red (R), green (G), and blue (B). For example, the color magenta may be about 50% red (R), about 0% green (G), and about 50% blue (B). When creating a full color pixel, it must be constructed of single color sub-pixels of each color component. The term “full color” will be used herein to signify the capability of showing a variety of colors which substantially represent the colors of the visible spectrum.

In an embodiment, a color filter matrix is used with the sub-pixels and can be placed below or above TFT array. Of course, if a black and white display is desired, the color filter matrix may be removed.

Typically, a grouping of individual single-color sub-pixels together forms a single full color pixel. For example, an individual full color pixel can be comprised of 16 single color sub-pixels. Each sub-pixel has its own liquid crystal segment which opens and closes depending on whether voltage is applied to the sub-pixel. Each full color pixel shows a different color depending on the different combinations of sub-pixels which are formed by turning individual sub-pixels on or off. Because of the pattern of RGB sub-pixels, this type of display is sometimes called a mosaic display. Although this exemplary full color pixel is a square of 16 sub-pixels, a pixel can be any number of sub-pixels in any viable shape. Furthermore, the order of colors may be any workable configuration. There are other ways of breaking down colors of the visible spectrum besides into RGB components, and the present invention is not limited to LCD color displays using RGB sub-pixels.

Optionally, the display of the invention can include additional component(s) such as a brightness enhancement filter or brightness enhancing film (“BEF”), a UV filter, a mask. For example, a layer of BEF can be located above the phosphor layer, and below the LCD panel. A UV filter may be used to remove light below 430 nm which may pass through display device. The mask may be located around the red, green, and blue emitting sub-pixels. A benefit of the mask is that it will mitigate “cross-talk” between adjacent sub-pixels. Suitable materials for the mask include metal, graphite, carbon black, and combinations thereof.

In an embodiment, the lighting device of the invention can be manufactured under controlled atmosphere conditions (separately from the TFT block). The lighting device can then be attached to a TFT block on one side and a light diffuser on the other. A LCD block including the TFT panel and polarizers and RGB filters can then be placed on the front side of the display device.

### EXAMPLES

### Example 1

### Model for Backlighting Panel

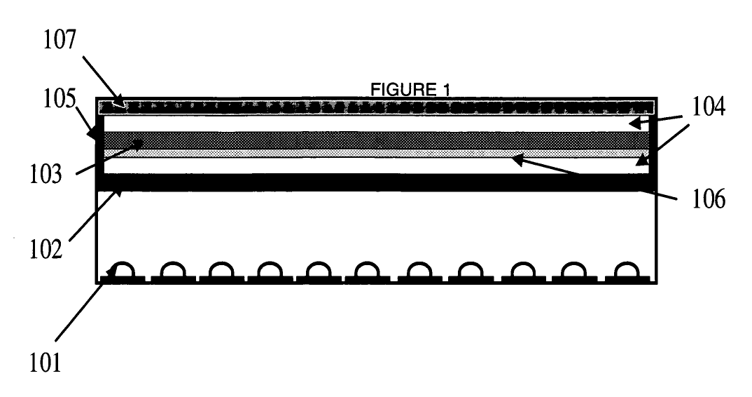

FIG. 1 depicts the side view of an exemplary display device which comprises a lighting device according to the present invention. With reference to FIG. 1, a plurality of LEDs 101 is located on the bottom panel of a housing with unrestricted spacing to size ratio. The housing is depicted as having a rectangular orientation; however, the invention is applicable to housing having any particular shape, size, or configuration. The bottom panel may include one or more integrated circuits (not shown). Integrated circuits may be used to drive LEDs 101 on the bottom panel. Additionally, the bottom panel may include one or more LED protective elements (not shown) to protect the diode of the LED from coming in physical contact with another tangible item. In one example, the protective element may comprise a ring shaped cone on the bottom panel in which a LED 101 is in the center of the recessed portion of the cone. In a second embodiment, the protective element may be a clear plastic cap over the top of the diode of each LED 101.

There is no specific restriction on the arrangement of LEDs 101. For example, they can be uniformly spaced apart. The can be spaced apart to provide a sufficiently uniform radiometric flux for the display device.

LEDs 101 can be the same or different. They can be separated from one another by any distance, for example greater or less than the width of a single LED. The ratio of the height of the housing to pitch of the LEDs can be in any value, for example, outside or inside the range of 0.3 to 1.2. Optionally, the LEDs are connected to perform a rectification of the AC supply voltage. Optionally, the vertical walls of the housing have a reflective surface.

In FIG. 1, an optional diffuser 102 is located above LEDs 101, and is aligned with LEDs 101 to diffuse the radiation emitted from LEDs 101. Placed above diffuser 102 is a secured phosphor layer 103 which comprises one or more moisture- and air-sensitive phosphors. Phosphor layer 103 is sandwiched between two glass plates 104. A perimeter seal 105 is applied around two glass plates 104, sealing phosphor layer 103 in the enclosed space confined by perimeter seal 105 and two glass plates 104. Inside the enclosed space, an optional RI matching layer 106 may be placed below phosphor layer 103. Radiation from LEDs 101, after passed through diffuser 102 and secured phosphor layer 103, can backlight a TFT block 107 with polarizers and filters etc. (not shown). Various parts in FIG. 1 are shown not to scale, for clarity. One skilled in the art will select the proper thickness and size to suit any particular application.

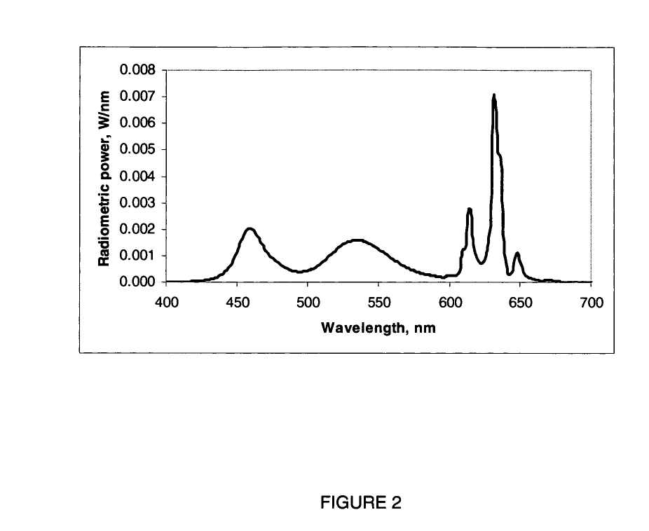

FIG. 2 shows the spectral power distribution of the blend (K₂[TiF₆]:Mn⁴⁺+SrGa₂S₄:Eu²⁺) using blue LED chips as the radiation source. This particular blend is balanced to a “daylight° CCT of 6500K together with the bleed from the LED chips, but virtually any other CCT of practical interest is achievable as well.

Particularly preferred suitable phosphors for blue LED chips (with a peak wavelength from about 440 to about 470 nm) include alkaline earth thiogallates activated with at least Eu²⁺, e.g. SrGa₂S₄:Eu²⁺ (as the green phosphor), alkali fluorides activated with Mn⁴⁺, e.g. K₂[SiF₆]:Mn⁴⁺ (as the red phosphor), and any combination thereof. Particularly preferred suitable phosphors for violet or UV LED chips (with a peak wavelength less than about 440 nm) include alkaline earth halophosphates activated with Eu²⁺, e.g. Sr₅(PO₄)₃Cl:Eu²⁺ (as the blue phosphor), alkaline earth thiogallates activated with at least Eu²⁺, e.g. SrGa₂S₄:Eu²⁺ (as the green phosphor), rare earth oxysulfides activated with at least Eu³⁺, e.g. La₂O₂S:Eu³⁺ (as the red phosphor), and any combination thereof. Other suitable phosphors for use in the present invention were specified above.

### Example 2

### Model for Curved Phosphor Layer

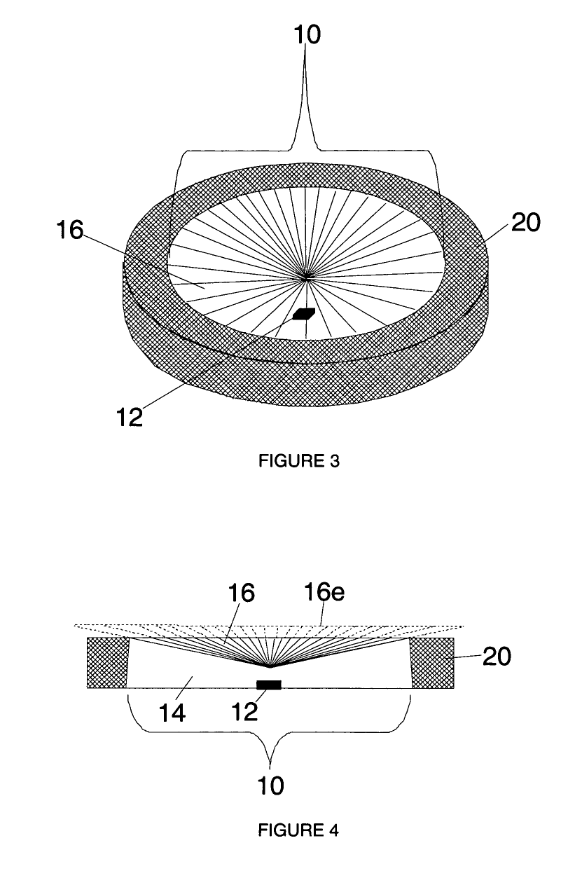

With reference to FIGS. 3 and 4, a side emitting light emitting diode (LED) device 10 includes at least one LED chip 12, such as at least one group III-nitride chip, at least one group III-phosphide chip, or so forth, that is encapsulated by an encapsulant 14 that is transmissive for illumination generated by the at least one LED chip 12. The encapsulant 14 includes a generally conical, frustoconical, wedge-shaped, or otherwise-shaped depression on which a reflector 16 is disposed, such that the reflector has a generally conical, frustoconical, wedge-shaped, or otherwise-shaped surface facing the at least one LED chip 12. The reflector 16 intercepts light from the LED chip 12 directed transverse to the plane in which the LED chip 12 resides, and reflects such transverse light into a sideways direction to contribute to the side emission of illumination. As a result, the LED device 10 is a side emitter that emits illumination sideways but emits substantially no illumination in the transverse direction.

Further included in the embodiment of FIGS. 3 and 4 is a wavelength conversion element 20 that comprises a layer of moisture sensitive phosphor as described above, wherein said layer of phosphor is located between opposed at least substantially transparent members comprised of a material substantially impervious to an external atmosphere, as described above. In the embodiment illustrated in FIG. 3, the wavelength conversion element 20 has the form of a generally annular ring of phosphor disposed at the periphery of the side emitting LED device 10. The generally annular wavelength conversion element 20 receives the side-emitted illumination from the side emitting LED device 10 and the phosphor converts the light to a different wavelength or spectral range. For example, the phosphor may comprise one or more phosphorescent or fluorescent materials dispersed in a matrix or host of epoxy, silicone, or so forth. In some embodiments, the side-emitted illumination is violet or ultraviolet and the wavelength conversion element 20 includes a mixture of reddish, greenish, bluish or other phosphor components in a stoichiometry selected to convert the violet or ultraviolet side-emitted illumination into white light. In other contemplated embodiments, blue side emitted illumination is converted wholly or in part to yellowish light by the phosphor, or ultraviolet light is converted to a saturated visible color by the phosphor, or so forth. The wavelength conversion performed by the wavelength conversion element 20 also reduces or eliminates the side emission directionality of the illumination, since typical phosphors, fluorphors, or so forth emit the wavelength converted light isotropically.

The phosphor of the wavelength conversion element 20 is spaced apart from the LED chip 12 at least by the encapsulant 14. Optionally, there may be an additional gap or space between the encapsulant 14 and the wavelength conversion element 20, which additional gap or space if included (not shown in FIG. 3) is transmissive for the side emitted illumination. Advantageously, spacing apart the phosphor from the LED chip 12 by at least the encapsulant 14 reduces or eliminates heating of the phosphor by the LED chip 12, which increases the overall efficiency of generation of wavelength converted light and reduces or eliminates heat-induced performance degradation over time. In some embodiments, the LED chip occupies less than or about one-tenth of an area contained inside the generally annular wavelength conversion element 20 so as to limit heating of the phosphor. However, other geometrical dimensions can be used.

The term “generally annular” as used herein is intended to encompass substantially any ring-shaped or looping structure. For example, a square or rectangular ring formed of four connecting sides is encompassed by the term “generally annular”, as is a substantially complete ring that includes one or more small gaps that break the ring continuity. The terms “light” and “illumination” as used herein are intended to encompass electromagnetic radiation in the visible spectrum and also in the neighboring infrared and ultraviolet spectral regions. The phosphor may convert the side emitted illumination either completely or partially, the latter configuration producing a blending of side emitted illumination and wavelength converted light. Still further, as used herein the term “side emitting LED device” is intended to encompass any electroluminescent diode device that generates side emitted illumination. For example, it is contemplated to replace the illustrated side emitting LED device 10 with an edge emitting semiconductor laser diode device, or with an LED device emitting primarily incoherent light but having some of the electrical and/or optical confinement features of an edge emitting semiconductor laser diode device. As used herein, the term “side emitting LED device” is intended to encompass edge emitting semiconductor laser diode devices.

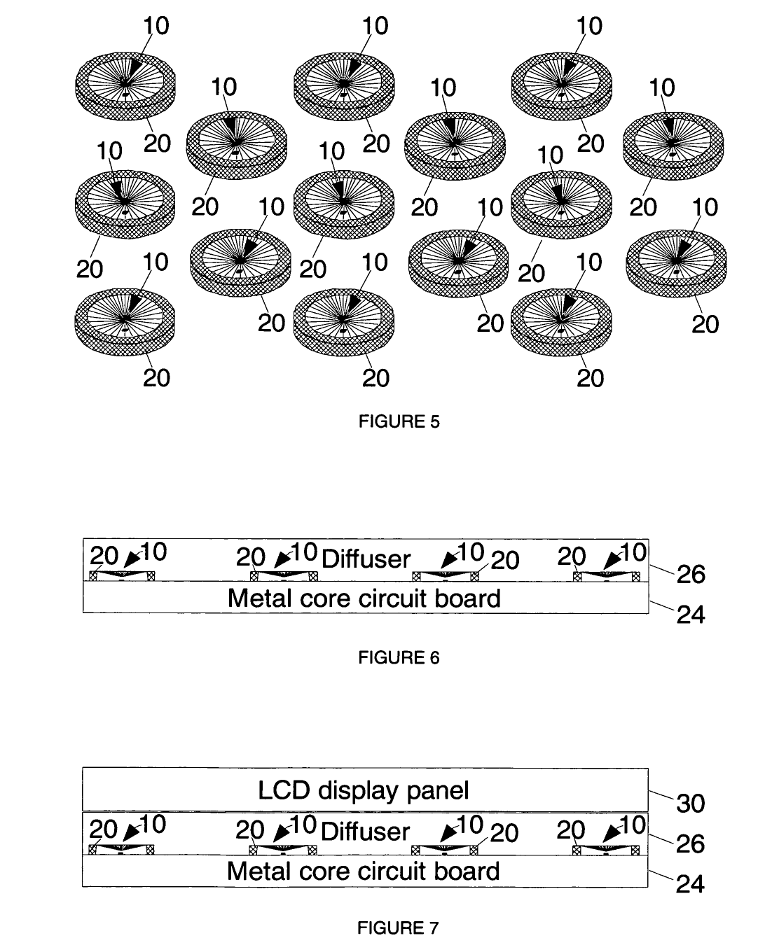

With reference to FIG. 5, the devices shown in FIGS. 3 and 4 including side emitting LED devices 10 each surrounded by one of the generally annular wavelength conversion elements 20 are arranged in a generally planar arrangement to provide a planar illumination device. Advantageously, because each LED chip 12 is covered by the reflector 16, bright spots due to direct viewing of the LED chips 12 are avoided. With brief reference back to FIG. 4, in some embodiments the reflector 16 includes an annular extension 16e that extends over the annular wavelength converting element 20 to deflect light emitting transverse to the plane into the in-plane direction. The remote arrangement of the phosphor reduces or eliminates efficiency losses and performance degradation over time due to heating. The spread out distribution of the phosphor in the form of relatively large-circumference annuluses (compared with the size of the LED chips 12) further enhances lighting uniformity. The phosphor also tends to emit light isotropically, which further contributes to uniformity of the planar light output. As a result, the density of LED chips can be substantially reduced compared with two-dimensional planar LED sources that rely upon phosphor coated LED chips. Another advantage in the case of ultraviolet LED chips is that the ultraviolet light is trapped by the reflector 16 and, for a suitable annulus thickness of the generally annular wavelength converting element 20, is close to 100% converted by the generally annular wavelength converting element 20, so that little or no ultraviolet light escapes. Still further, the side emitting LED devices 10 are readily manufactured with low profiles, so that the generally planar light source provided by an array of the devices 10, 12 is a thin, low-profile planar light source.

With reference to FIG. 6, a generally planar light source based on the generally planar arrangement of FIG. 5 suitably includes a metal core circuit board 24, such as a metal core printed circuit board (MCPCB), on which the side emitting LED devices 10 are mounted. The metal core circuit board 24 includes a planar heat sink of copper or another material having high heat conductivity and/or high heat capacity so as to provide heatsinking for the side emitting LED devices 10. Circuitry of the metal core circuit board 24 provides convenient electrical interconnection of the devices 10, 12 of the generally planar array of devices 10, 12. In some embodiments, the surface of the metal core circuit board 24 on which the devices 10, 12 are mounted is specularly reflective or diffusely scattering for the wavelength converted light, so as to recover “downward” directed wavelength converted light to enhance the efficiency and light output of the planar light source.

Additionally, in the planar light source embodiment of FIG. 6 the side emitting LED devices 10 and surrounding wavelength conversion elements 20 are embedded in a diffuser or waveguide element 26. In this way, the potential for dim spots over the side emitting LED devices 10 due to shadowing by the reflectors 16 is reduced or eliminated by scattering and/or waveguiding of the wavelength converted light that homogenizes the wavelength converted light intensity across the area of the planar illumination device. The illustrated diffuser or waveguide element 26 extends over the low-profile side emitting LED devices 10 to provide light scattering or waveguiding over these devices to ensure that the uniform light distribution encompasses the areas directly “above” the reflectors 16. Because bright spots due to direct viewing of the LED chips 12 are avoided, and the light is spread out and generally isotropic due to the distributed arrangement of the wavelength conversion elements 20, it follows that the diffuser or waveguide 26 can be made thinner than in comparable two-dimensional planar LED light sources that rely solely upon the thick diffuser to remove bright spots due to direct viewing of LED chips, while still providing light uniformity.

With reference to FIG. 7, the planar illumination device of FIG. 6 is suitably coupled with a liquid crystal display (LCD) panel 30 to provide backlighting for the LCD panel 30. The overall thickness of the display of FIG. 7 can be made small because of the thin diffuser or waveguiding element 26, and the low profiles of the side emitting LED devices 10 and coupled wavelength conversion elements 20. Although an LCD backlighting application is illustrated with reference to FIG. 7 as an example, it is to be appreciated that the planar illumination device of FIG. 6 can be used in substantially any application that benefits from a thin, high intensity planar illumination device. For example, the planar illumination device of FIG. 6 can also be used in illuminated signage, architectural lighting, and so forth.

One potential source of optical losses in the arrangements of FIGS. 5-7 is reabsorption of wavelength converted light by neighboring wavelength conversion elements 20. These losses are expected to be relatively small due to the relatively low density of LED devices in the array and the generally isotropic emission profile of the phosphor. However, reabsorption losses can be problematic in some specific embodiments. For example, if the annulus thickness of the generally annular wavelength conversion elements 20 is small compared with the height of these elements, then the emission profile for the wavelength conversion elements 20 may be biased toward in-plane emission by the high aspect ratio, and this anisotropic converted light emission profile may have enhanced susceptibility to reabsorption by neighboring high aspect-ratio wavelength conversion elements 20.

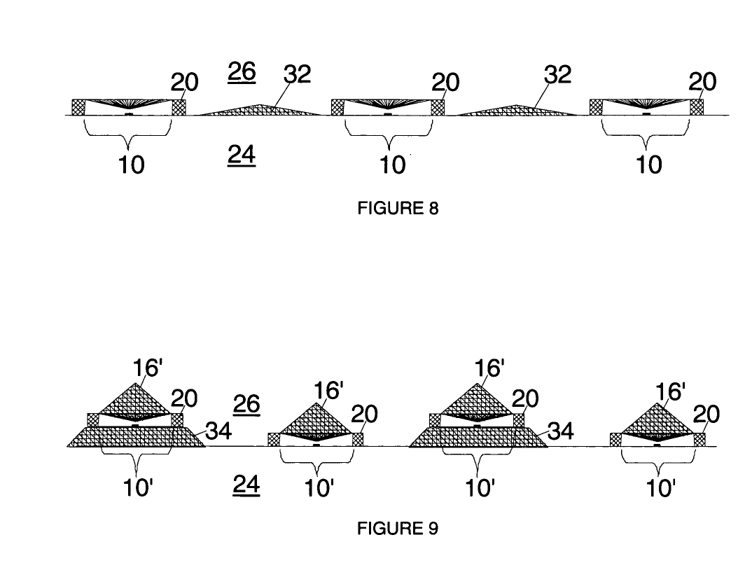

With reference to FIG. 8, one approach for reducing reabsorption losses is to embed light scattering elements 32 in the generally planar waveguide 26. In the illustrative embodiment shown in FIG. 8, the light scattering elements 32 are mounted on the metal core circuit board 24 and have a conical shape, frustoconical shape, wedge shape or other shape that promotes specular reflection or diffuse reflection or scattering of wavelength converted light traveling close to parallel to the plane of the planar light source. The reflected or scattered light can pass over the neighboring low profile wavelength conversion elements 20, thus avoiding optical loss and promoting light output uniformity in the areas over the reflectors 16.

FIG. 9 illustrates another contemplated approach for reducing reabsorption losses. In the embodiment of FIG. 9 a portion, such as half, of the side emitting LED devices 10 and their surrounding wavelength converting elements 20 are formed as elevated units by mounting on pedestals 34. This reduces the likelihood of reabsorption by placing some units above others. Optionally, the pedestals 34 can have slanted sides with specularly reflecting of diffusely reflecting or scattering surfaces, so that wavelength converted light emitted from non-elevated units that travels close to parallel with the plane of the planar light source are reflected by the pedestals 34 into a generally transverse direction to contribute to the light output of the planar light source. In similar fashion, the reflectors 16 are optionally replaced by modified reflectors 16′ that further promote reflection of the waveguided or scattered light into the transverse direction to contribute to the light output of the planar light source.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A lighting device, which comprises one or more radiation sources and a layer of moisture sensitive phosphor, wherein said layer of phosphor is located between opposed at least substantially transparent members comprised of a material substantially impervious to an external atmosphere.

2. The lighting device of claim 1, wherein the phosphor is selected from sulfides, selenides, tellurides, activated with at least one of Ce³⁺ and Eu²⁺, thiogallates and thioaluminates activated with at least one of Ce³⁺ and Eu²⁺, oxysulfides activated with at least Eu³⁺, complex fluorides activated with Mn⁴⁺, and any combination thereof.

3. The lighting device of claim 1, wherein the phosphor is selected from alkaline earth thiogallates activated with at least Eu²⁺, rare earth oxysulfides activated with at least Eu³⁺, alkali fluorides activated with Mn⁴⁺, and any combination thereof.

4. The lighting device of claim 2, wherein the complex fluoride activated with Mn⁴⁺ is selected from (1) A₂[MF₆]:Mn⁴⁺, wherein A is selected from Li, Na, Rb, Cs, NH₄, and combinations thereof; and M is selected from Ge, Si, Sn, Ti, Zr, Hf and combinations thereof; (2) A₃[MF₆]:Mn⁴⁺, wherein A is selected from Li, Na, Rb, Cs, NH₄, and combinations thereof; and M is selected from Al, Ga, In Bi, Sc, Y, a rare earth; and any combination thereof.

5. The lighting device of claim 2, wherein the complex fluoride activated with Mn⁴⁺ is selected from K2[TiF₆]:Mn⁴⁺, (K,Cs)[SiF₆]:Mn⁴⁺, and any combination thereof.

6. The lighting device of claim 1, wherein the phosphor comprises SrGa₂S₄:Eu²⁺.

7. The lighting device of claim 1, wherein the phosphor optionally comprises an additional phosphor that is selected from the group including: (Ba,Sr,Ca)₅(PO₄)₃(Cl,F,Br,OH):Eu²⁺,Mn²⁺; (Ba,Sr,Ca)BPO₅:Eu²⁺,Mn²⁺; (Sr,Ca)₁₀(PO₄)₆*vB₂O₃:Eu²⁺ (wherein 0<v≦1); Sr₂Si₃O₈*2SrCl₂:Eu²⁺; (Ca,Sr, Ba)₃MgSi₂O₈:Eu²⁺, Mn²⁺; BaAl₈O₁₃:Eu²⁺; 2SrO*0.84P₂O₅*0.16B₂O₃:Eu²⁺; (Ba,Sr,Ca)MgAl₁₀O₁₇:Eu²⁺, Mn²⁺; (Ba,Sr,Ca)Al₂O₄:Eu²⁺; (Y,Gd,Lu,Sc,La)BO₃:Ce³⁺,Tb³⁺; ZnS:Cu³⁺,Cl⁻; ZnS:Cu⁺,Al³⁺; ZnS:Ag⁺,Cl⁻; ZnS:Ag⁺,Al³⁺; (Ba,Sr,Ca)₂Si_{1-ξ}O_{4-2ξ}:Eu²⁺ (wherein 0≦ξ≦0.2); (Ba,Sr,Ca)₂(Mg,Zn)Si₂O₇:Eu²⁺; (Sr,Ca,Ba)(Al,Ga,In)₂S₄:Eu²⁺; (Y,Gd,Tb,La,Sm,Pr,Lu)₃(Al,Ga)_{5-α}O_{12-3/2α}:Ce³⁺ (wherein 0≦α≦0.5); (Ca,Sr)₈(Mg,Zn)(SiO₄)₄Cl₂:Eu²⁺, Mn²⁺; Na₂Gd₂B₂O₇:Ce³⁺,Tb³⁺; (Sr,Ca,Ba,Mg,Zn)₂P₂O₇:Eu²⁺,Mn²⁺; (Gd,Y,Lu,La)₂O₃:Eu³⁺, Bi³⁺; (Gd,Y,Lu,La)₂O₂(S,Se,Te):Eu³⁺, Bi³⁺; (Gd,Y,Lu,La)VO₄:Eu³⁺,Bi³⁺; (Ba,Sr,Ca)MgP₂O₇:Eu²⁺, Mn²⁺; (Y, Lu)₂WO₆:Eu³⁺,Mo⁶⁺; (Ba,Sr,Ca)_{β}Si_{γ}N_{μ}:Eu²⁺ (wherein 2β+4γ=3μ); Ca₃(SiO₄)Cl₂:Eu²⁺; (Lu,Sc,Y,Tb)₂₋ᵤ₋ᵥCeᵥCa₁₊ᵤLi_{w}Mg_{2-w}P_{w}(Si,Ge)_{3-w}O_{12-u/2} (where −0.5≦u≦1, 0<v≦0.1, and 0≦w≦0.2); ((Y,Lu,Gd)_{2-φ}Ca_{φ}Si₄N_{6+φ}C_{1-φ}:Ce³⁺, (wherein 0≦φ≦0.5); (Lu,Ca,Li,Mg,Y)alpha-SiAlON doped with Eu²⁺ and/or Ce³⁺; (Ca,Sr,Ba)SiO₂N₂:Eu²⁺,Ce³⁺; 3.5MgO*0.5MgF₂*GeO₂:Mn⁴⁺; Ca_{1-c-f}Ce_{c}Eu_{f}Al_{1+c}Si_{1-c}N₃, (where 0<c≦0.2, 0≦f≦0.2); Ca₁₋ₕ₋ᵣCeₕEuᵣAl₁₋ₕ(Mg,Zn)ₕSiN₃, (where 0<h÷0.2, 0≦r≦0.2); Ca₁₋₂ₛ₋ₜCeₛ(Li,Na)ₛEuₜAlSiN₃, where 0≦s≦0.2, 0≦f≦0.2, s+t>0); Ca_{1-σ-χ-φ}Ce_{σ}(Li,Na)_{χ}Eu_{φ}Al_{1+σ-χ}Si_{1-σ+χ}N₃, (where 0≦σ≦0.2, 0<χ≦0.4, 0≦φ≦0.2), and any combination thereof.

8. The lighting device of claim 1, wherein the opposed at least substantially transparent members are plates, and a perimeter seal envelopes edges of said plates.

9. The lighting device of claim 8, wherein said perimeter seal comprises an adhesive tape that comprises at least one layer of air- and moisture-impermeable material.

10. The lighting device of claim 8, wherein the plates are made of glass.

11. The lighting device of claim 8, wherein the perimeter seal comprises UV curable acrylic or epoxy.

12. The lighting device of claim 1, further including a RI matching layer between the plates.

13. The lighting device of claim 1, wherein the radiation source comprises one or more a light emitting diodes (LED).

14. The lighting device of claim 1, further including a light diffuser placed between the radiation source(s) and the phosphor layer.

15. A display device comprising one or more radiation sources and a layer of secured phosphor, wherein said layer of phosphor is located between opposed at least substantially transparent members comprised of a material substantially impervious to an external atmosphere.

16. The display device of claim 15, which is a LCD display including a polarizer, an array of thin film transistors (TFT) and color filter.

17. The display device of claim 16, further including a brightness enhancement filter or brightness enhancing film (“BEF”), a UV filter, a mask, or a combination thereof.

18. A backlighting device, which comprises one or more radiation sources and a layer of moisture sensitive phosphor, wherein said layer of phosphor is located between opposed at least substantially transparent members comprised of a material substantially impervious to an external atmosphere.

19. The backlighting device of claim 18, wherein the phosphor is selected from sulfides, selenides, tellurides, activated with at least one of Ce³⁺ and Eu²⁺, thiogallates and thioaluminates activated with at least one of Ce³⁺ and Eu²⁺, oxysulfides activated with at least Eu³⁺, complex fluorides activated with Mn⁴⁺, and any combination thereof.

20. The backlighting device of claim 18, wherein the phosphor is selected from alkaline earth thiogallates activated with at least Eu²⁺, rare earth oxysulfides activated with at least Eu³⁺, alkali fluorides activated with Mn⁴⁺, and any combination thereof.
